(19) United States
(12) Patent Application Publication
(10) Pub. No.: US 2024/0157897 A1
(43) Pub. Date: May 16, 2024

(54) DEVICE FOR MOBILE OBJECT AND CONTROL METHOD FOR MOBILE OBJECT

(71) Applicant: DENSO CORPORATION, Kariya-city (JP)

(72) Inventors: Haozhou LI, Kariya-city (JP); Masafumi NOHARA, Kariya-city (JP); Natsuko MIYAZAKI, Kariya-city (JP); Keiji OKAMOTO, Kariya-city (JP); Taro KOBAYASHI, Kariya-city (JP); Asuka SAKAI, Kariya-city (JP); Kazuhiro MATSUI, Kariya-city (JP); Jinhae CHOI, Kariya-city (JP)

(21) Appl. No.: 18/389,773

(22) Filed: Dec. 19, 2023

Related U.S. Application Data
(63) Continuation of application No. PCT/JP22/21886, filed on May 30, 2022.

(30) Foreign Application Priority Data
Jun. 25, 2021 (JP) 2021-106090

(51) Int. Cl. B60R 16/037; G10L 17/06

(52) U.S. Cl. CPC B60R 16/0373; G10L 17/06

(57) ABSTRACT

A device for mobile object, which is usable in a mobile object, includes an occupant information specifying unit and a request estimation unit. The occupant information specifying unit specifies an occupant information record for each of multiple occupants existing in the mobile object by distinguishing the multiple occupants from one another. The multiple occupants are detected by a sensor of the mobile object. The request estimation unit estimates a request of one of the multiple occupants corresponding to a combination of the occupant information records of the multiple occupants based on the occupant information records of the multiple occupants specified by the occupant information specifying unit.

### CROSS REFERENCE TO RELATED APPLICATIONS

The present application is a continuation application of International Patent Application No. PCT/JP2022/021886 filed on May 30, 2022, which designated the U.S. and claims the benefit of priority from Japanese Patent Application No. 2021-106090 filed on Jun. 25, 2021. The entire disclosures of all of the above applications are incorporated herein by reference.

### TECHNICAL FIELD

The present disclosure relates to a device for mobile object and a control method for mobile object.

### BACKGROUND

There has been known a technique of acquiring, from a personal information database, personal information corresponding to an occupant who gets on board and providing information based on the acquired personal information to the occupant when the occupant gets on board again.

### SUMMARY

The present disclosure provides a device for mobile object. The device is usable in a mobile object, and includes an occupant information specifying unit and a request estimation unit. The occupant information specifying unit specifies an occupant information record for each of multiple occupants existing in the mobile object by distinguishing the multiple occupants from one another. The multiple occupants are detected by a sensor of the mobile object. The request estimation unit estimates a request of one of the multiple occupants corresponding to a combination of the occupant information records of the multiple occupants based on the occupant information records of the multiple occupants specified by the occupant information specifying unit. The occupant information specifying unit specifies, as the occupant information record, a voice content of each of the multiple occupants by distinguishing the multiple occupants from one another. The voice content of each of the multiple occupants is detected by the sensor of the mobile object, which detects a sound in a compartment of the mobile object. The request estimation unit estimates the request of one of the multiple occupants corresponding to a combination of the voice contents of the multiple occupants based on the voice contents of the multiple occupants specified by the occupant information specifying unit. The request estimation unit estimates a background of a conversation content based on the conversation content that is a flow of the voice contents of the multiple occupants specified by the occupant information specifying unit, and estimates the request of one of the multiple occupants to match the estimated background.

### BRIEF DESCRIPTION OF DRAWINGS

Objects, features and advantages of the present disclosure will become apparent from the following detailed description made with reference to the accompanying drawings. In the drawings:

FIG. 1 is a diagram showing an example of a schematic configuration of a vehicle system;

FIG. 2 is a diagram showing an example of a schematic configuration of an HCU; and

FIG. 3 is a flowchart showing an example of a flow of provision related process executed by the HCU.

### DETAILED DESCRIPTION

In a vehicle, a request from the occupant changes depending on a relationship between or among multiple occupants, and also changes depending on states of respective occupants in the vehicle. Thus, it is difficult to accurately estimate the request from the occupant only based on the personal information of the occupant. Since it is difficult to accurately estimate the request from the occupant, it is difficult to provide a comfortable in-vehicle experience that meets the request of occupant.

According to an embodiment of the present disclosure, a device for mobile object is provided. The device is usable in a mobile object, and includes an occupant information specifying unit and a request estimation unit. The occupant information specifying unit specifies an occupant information record for each of multiple occupants existing in the mobile object by distinguishing the multiple occupants from one another. The multiple occupants are detected by a sensor of the mobile object. The request estimation unit estimates a request of one of the multiple occupants corresponding to a combination of the occupant information records of the multiple occupants based on the occupant information records of the multiple occupants specified by the occupant information specifying unit. The occupant information specifying unit specifies, as the occupant information record, a voice content of each of the multiple occupants by distinguishing the multiple occupants from one another. The voice content of each of the multiple occupants is detected by the sensor of the mobile object, which detects a sound in a compartment of the mobile object. The request estimation unit estimates the request of one of the multiple occupants corresponding to a combination of the voice contents of the multiple occupants based on the voice contents of the multiple occupants specified by the occupant information specifying unit. The request estimation unit estimates a background of a conversation content based on the conversation content that is a flow of the voice contents of the multiple occupants specified by the occupant information specifying unit, and estimates the request of one of the multiple occupants to match the estimated background.

According to another embodiment of the present disclosure, a control method for mobile object is provided. The control method for mobile object is executed by at least one processor, and is usable in a mobile object. The control method includes: specifying an occupant information record for each of multiple occupants existing in the mobile object by distinguishing the multiple occupants from one another, the multiple occupants being detected by a sensor of the mobile object; detecting a voice content of each of the multiple occupants using the sensor of the mobile object, which detects a sound in a compartment of the mobile object; specifying, as the occupant information record, the voice content of each of the multiple occupants by distinguishing the multiple occupants from one another; estimating the request of one of the multiple occupants corresponding to a combination of the voice contents of the multiple occupants based on the specified voice contents of the multiple occupants; estimating a background of a conversation content based on the conversation content that is a flow of the specified voice contents of the multiple occupants; and estimating the request of one of the multiple occupants to match the estimated background.

According to the above configurations, the occupant request corresponding to the combination of occupant information records of multiple occupants is estimated based on the occupant information records of multiple occupants, who exist in the mobile object, and the individual occupants existing in the mobile object are specified in distinguishable manner. Thus, it is possible to more accurately estimate the occupant request that changes depending on the relationship among the multiple occupants and respective states of the multiple occupants. Since the occupant information is information about the occupant in the mobile object and the occupant is detected by the sensor of the mobile object, it is possible to more accurately estimate the request of occupant suitable for the actual situation. As a result, it is possible to provide a comfortable indoor experience and more suitable response to the request of occupant by accurately estimating the request of occupant when multiple occupants exist in the vehicle.

The following will describe multiple embodiments of the present disclosure with reference to the drawings. For convenience of description, any part functioning identically to a part depicted in any figure having been referred to in foregoing description will be denoted by an identical reference symbol and may not be described repeatedly in the following embodiments. For the elements denoted by the same reference symbols, the description thereof may be referred to in other embodiments.

### First Embodiment

### Schematic Configuration of Vehicle System 1

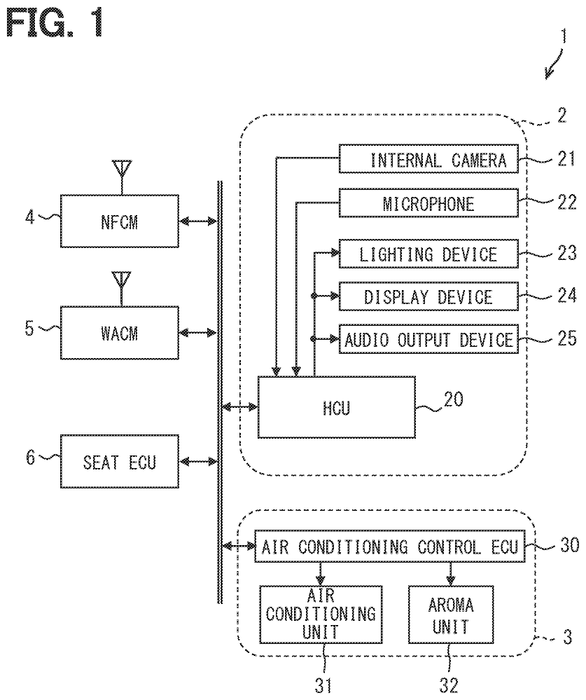

The following will describe a first embodiment with reference to the accompanying drawings. A vehicle system 1 illustrated in FIG. 1 may be used in, for example, an automobile (hereinafter, simply referred to as a vehicle). The vehicle system 1 includes a human machine interface (HMI) system 2, an air conditioning system 3, a near field communication module (hereinafter referred to as NFCM) 4, a wide area communication module (hereinafter referred to as WACM) 5, and a seat ECU 6. For example, the HMI system 2, the air conditioning system 3, the NFCM 4, the WACM 5, and the seat ECU 6 may be connected to an in-vehicle LAN. Hereinafter, a vehicle equipped with the vehicle system 1 may be referred to as a host vehicle.

The air conditioning system 3 is a cooling system or a heating system of a vehicle. The air conditioning system 3 acquires air conditioning request information including air conditioning related setting values and the like set by the user of the host vehicle from the HCU 20 described later. Then, the air conditioning system 3 adjusts, in accordance with the acquired air conditioning request information, the temperature, airflow, fragrance, and the like in the vehicle compartment of the host vehicle. The air conditioning system 3 includes an air conditioning control ECU 30, an air conditioning unit 31, and an aroma unit 32.

The air conditioning unit 31 generates warm air or cold air (hereinafter, conditioned air). The conditioned air is supplied into the vehicle compartment from an air outlet arranged in, for example, an instrument panel of the host vehicle. The aroma unit 32 includes beads or the like (hereinafter, referred to as an impregnated material) impregnated with an aroma oil such as an essential oil containing an aromatic component. The air flow generated by the air conditioning unit 31 is passed around the impregnated material to supply the aroma into the vehicle compartment. Alternatively, the aroma unit 32 may atomize the aroma oil. In this case, the aroma component atomized by the aroma unit 32 may be mixed with the airflow generated by the air conditioning unit 31 and then supplied into the vehicle compartment. The air conditioning unit 31 gives a stimulus to an occupant by supplying airflow to an occupant in the host vehicle. The air conditioning unit 31 may give a thermal stimulus to an occupant in the host vehicle by changing a temperature of the conditioned air. That is, the air conditioning unit 31 gives a tactile stimulus. The aroma unit 32 provides stimulation by aroma to the occupant of host vehicle. That is, the aroma unit 32 gives an olfactory stimulus. Each of the air conditioning unit 31 and the aroma unit 32 is a presentation device that presents a stimulus. The air conditioning control ECU 30 is an electronic control unit that controls operations of the air conditioning unit 31 and the aroma unit 32. The air conditioning control ECU 30 is connected to the air conditioning unit 31 and the aroma unit 32.

The NFCM 4 is a communication module for performing short-range wireless communication. When a communication connection is established with a mobile terminal carried by an occupant in the host vehicle, the NFCM 4 performs short-range wireless communication with the mobile terminal. The short-range wireless communication is, for example, wireless communication whose communication range is about several tens of meters at the maximum. As the short-range wireless communication, for example, wireless communication conforming to Bluetooth (registered trademark) Low Energy may be used. Examples of the mobile terminal include a multifunctional mobile phone, a wearable device, or the like. The WACM 5 transmits and receives information to and from a center located outside the host vehicle via wireless communication. That is, the WACM 5 performs a wide area communication.

The seat ECU 6 is an electronic control unit that executes various processes related to control of a seat environment, such as adjustment of a seat position of a seat of host vehicle. In the following description, it is assumed that the seat of host vehicle is an electric seat whose slide position and reclining position can be electrically changed. When the seat of the host vehicle is not an electric seat, the seat ECU 6 may be omitted. Examples of the seat include a driver seat, a passenger seat, and a rear seat. The electric seat may be provided to a part of the driver seat, the passenger seat, and the rear seat. The slide position is a position of the seat in a front-rear direction of the host vehicle. The reclining position is an angle of the backrest of the seat. The backrest of the seat can also be referred to as a seat back.

The HMI system 2 acquires information on the occupant, and presents a stimulus to the occupant. The stimulus here includes provision of information. Details of the HMI system 2 will be described below.

(Schematic Configuration of HMI System 2)

The HMI system 2 includes a human machine interface control unit (HCU) 20, an internal camera 21, a microphone 22, a lighting device 23, a display device 24, and an audio output device 25.

The internal camera 21 captures an image of a predetermined range in the vehicle compartment of the host vehicle. The internal camera 21 captures an image of a range including the driver seat, the passenger seat, and the rear seat of the host vehicle. Multiple camera units may be used as the internal camera 21, and the imaging range may be shared by multiple camera units. The internal camera 21 includes, for example, a near-infrared light source, a near-infrared camera unit, and a control unit that controls these components. The internal camera 21 may capture an image of the occupant using the near-infrared camera unit after irradiating the occupant with the near-infrared light using the near-infrared light source. An image captured by the near-infrared camera unit is analyzed by the control unit. The control unit detects an awakening level, a face direction, a line-of-sight direction, a posture, or the like of the occupant based on feature amounts of the occupant extracted by the control unit performing image analysis on the captured image. The awakening level may be detected based on, for example, an opening or closing degree of an eyelid of the occupant.

The microphone 22 collects a voice uttered by an occupant of the host vehicle, converts the voice into an electrical audio signal, and outputs the electrical audio signal to the HCU 20. The microphone 22 is preferably provided for each seat so as to be able to distinguish and collect the voice of the occupant in each seat. When a configuration in which individual occupants are distinguished and specified by voice recognition as described later, the microphone 22 may not be provided for each seat. As the microphone 22 provided for each seat, a zoom microphone with narrowed directivity may be used.

The lighting device 23 is located in the vehicle such that the occupant can visually recognize the lighting device 23. The lighting device 23 stimulates the occupant by light emission. That is, the lighting device gives a visual stimulus. The lighting device 23 corresponds to a presentation device that presents a stimulus. As the lighting device 23, a light emitting device such as an LED may be used. The lighting device 23 is preferably capable of switching a color of light emission. The HCU 20 controls a light emission executed by the lighting device 23.

The display device 24 displays information. The display device 24 is located in the vehicle such that the occupant can visually recognize the display device, and gives a stimulus by performing a display to the occupant. That is, the display device gives a visual stimulus. The display device 24 corresponds to a presentation device that presents a stimulus. The display device 24 preferably displays at least an image. The display device 24 may display text or the like in addition to the image. The HCU 20 controls a display operation of the display device 24. As the display device 24, for example, a meter MID (Multi Information Display), a CID (Center Information Display), a rear seat display, a transparent display, or a transmissive surface display can be used.

The meter MID is a display device located in front of the driver seat in the vehicle compartment. As an example, the meter MID may be provided on a meter panel. The CID is a display device located at the center of instrument panel of the host vehicle. The rear seat display is a display device for an occupant in a rear seat of the host vehicle. The rear seat display may be equipped to a ceiling, a seat back of the driver seat or the passenger seat with a display surface facing the rear side of the host vehicle. The transparent display refers to a transmissive display device. Examples of the transparent display include an OLED (Organic Electro-Luminescence). The transparent display may be provided on a window of the host vehicle. The transmissive surface display is a display device that performs display through a transmissive surface. The transmissive surface display may be provided on a door trim, a seat back, a floor roof, or the like of the host vehicle.

The audio output device 25 gives a stimulus by sound to the occupant. That is, the audio output device gives an auditory stimulus. The audio output device 25 corresponds to a presentation device that presents a stimulus. Examples of the sound output from the audio output device 25 include music and environmental sound. The music may include BGM. The environmental sound may be a sound that reproduces a specific environment. As the audio output device 25, for example, an audio speaker that outputs sound may be used.

The HCU 20 mainly includes a microcomputer, and the microcomputer includes a processor, a memory, an I/O, and a bus connecting these components. The HCU 20 executes a control program stored in a memory to execute various processes, such as a process related to provision of internal environment of the host vehicle (hereinafter, referred to as a provision related process). The HCU 20 corresponds to a device for mobile object. The memory referred to here is a non-transitory tangible storage medium that stores computer-readable programs and data in a non-transitory manner. The non-transitory tangible storage medium is implemented by a semiconductor memory, a magnetic disk, or the like. A schematic configuration of the HCU 20 will be described below.

(Schematic Configuration of HCU 20)

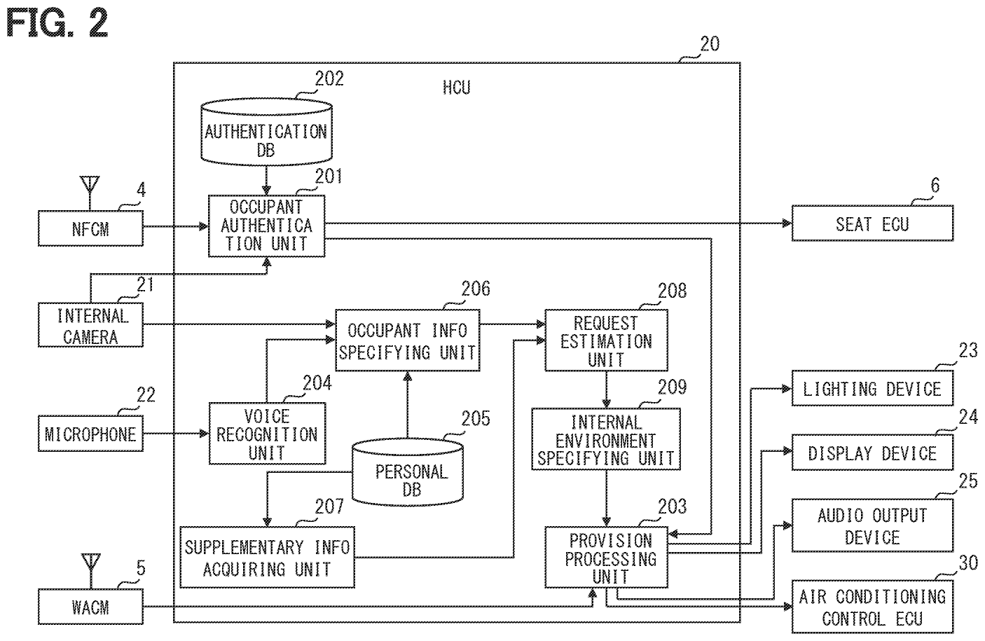

The following will describe a schematic configuration of the HCU 20 with reference to FIG. 2. As illustrated in FIG. 2, the HCU 20 includes, as functional blocks, an occupant authentication unit 201, an authentication database (hereinafter, DB) 202, a provision processing unit 203, a voice recognition unit 204, a personal DB 205, an occupant information specifying unit 206, a supplementary information acquiring unit 207, a request estimation unit 208, and an internal environment specifying unit 209. The execution of the processes of these functional blocks by the computer corresponds to execution of a control method for mobile object. Partial or all of the functions executed by the HCU 20 may be implemented by hardware, such as one or more ICs. Partial or all of the functional blocks included in the HCU 20 may be implemented by a combination of software executed by a processor and hardware components.

The occupant authentication unit 201 authenticates an authorized occupant of the host vehicle. The authentication may be performed by comparing occupant information with authorized occupant information registered in advance in the authentication DB 202. A non-volatile memory may be used as the authentication DB 202. The authentication DB 202 may be provided in a center communicable via the WACM 5. Various authentication methods may be used for the authentication. For example, it is preferable to perform authentication using a sensor of host vehicle, or perform authentication in cooperation with a mobile terminal of an occupant of the host vehicle.

For example, as the authentication using the sensor of host vehicle, face authentication may be performed using a feature amount of a face of the occupant, which is detected from the captured image captured by the internal camera 21. Alternatively, iris authentication using a feature amount of an iris of the occupant detected from the captured image may be performed. When a fingerprint sensor is provided on a door handle of the vehicle, fingerprint authentication using a fingerprint detected by the fingerprint sensor may be performed. Examples of the authentication in cooperation with the mobile terminal of the occupant of the host vehicle include code collation using identification information of each occupant stored in the mobile terminal. The occupant authentication unit may acquire the identification information from the mobile terminal via the NFCM 4. In addition to the authentication, the occupant authentication unit 201 may specify whether the occupant is the driver or the passenger based on a boarding position of the occupant. The boarding position may be detected by a seat sensor, or may be estimated from a vehicle door whose opening/closing is detected. Each occupant may be specified based on identification information stored in the mobile terminal.

The occupant authentication unit 201 may use various different authentication methods in order to increase the accuracy of authentication. As a specific example, authentication success by various authentication methods may be set as a condition for authentication success. The occupant authentication unit 201 may use various authentication methods for quick authentication. As a specific example, an adjustment of seat position for each occupant, a start of operation of the air conditioning, and the like may be enabled by authentication in cooperation with the mobile terminal of the occupant before the occupant gets in the vehicle.

The provision processing unit 203 provides various internal environments by controlling various presentation devices of the host vehicle. The provision processing unit 203 may provide the internal environment in which the hospitality performance is produced, for example, when the authentication of the occupant is succeeded by the occupant authentication unit 201. Examples of the internal environment where the hospitality performance is carried out may include adjustment of seat position for each occupant, display of an image related to the hospitality performance, lighting related to the hospitality performance, and audio output related to the hospitality performance. The adjustment of seat position for each occupant may be implemented by an instruction to the seat ECU 6. The seat position for each occupant may be specified by storing, in associated manner, the identification information of the mobile terminal and the seat position for each occupant in advance. The lighting may be implemented by controlling the lighting device 23. The display of image may be implemented by controlling the display device 24. The audio output may be implemented by controlling the audio output device 25.

The voice recognition unit 204 performs voice recognition on the voice collected by the microphone 22 to recognize the content of voice made by the occupant. In a case where the microphone 22 is provided for each seat, the voice recognition unit 204 may distinguish and specify the content of voice made by each occupant based on the difference in microphones 22 that collect the sound. Even when the microphone 22 is not provided for each seat, the content of voice made by each occupant may be distinguished and specified in proper manner.

The personal DB 205 stores information on each occupant in advance. A non-volatile memory may be used as the personal DB 205. The information on individual occupant includes information for specifying individual occupant (hereinafter referred to as occupant specifying information). As the information on individual occupant, at least one of information on a preference of individual occupant or information on a past movement history may be used. The information on a preference of individual occupant or the information on a past movement history may be referred to as supplementary information. The personal DB 205 may be provided in a center communicable via the WACM 5.

As the occupant specifying information, for example, an attribute of occupant, biological information of occupant, identification information of mobile terminal of the occupant, or the like may be associated with each occupant. The attribute of occupant may be a relationship with a predetermined person as a reference. Hereinafter, the predetermined person will be described as a person himself/herself. Examples of the attribute of occupant may include the person himself/herself, wife, grandfather, grandmother, son of a certain age or more (hereinafter referred to as son), daughter of a certain age or more (hereinafter referred to as daughter), infant of less than a certain age (hereinafter referred to as infant), friend of the person himself/herself, friend of the wife, friend of the son, and friend of the daughter. The attribute of occupant may be an attribute other than the examples of attribute described here. The attribute may be an attribute more subdivided than the examples of attribute described here. For example, when there are multiple grandfathers, grandmothers, sons, daughters, infants, and friends, they may be distinguished in detail. For example, the user may be a friend A, a friend B, a friend C, or the like. Examples of the biometric information of occupant include a feature amount extracted from a face image and a voiceprint. As the supplementary information, for example, at least one of information on a preference of occupant (hereinafter referred to as preference information) or information on a past movement history (hereinafter referred to as movement history information) may be associated with each occupant.

The occupant information specifying unit 206 specifies information of an occupant (hereinafter referred to as occupant information or occupant information record) who exists in the host vehicle and is detected by a sensor of the host vehicle by distinguishing each occupant from one another. The process executed by the occupant information specifying unit 206 corresponds to an occupant information specifying step. When distinguishing and specifying individual occupants of the host vehicle, it is preferable to also specify attributes of individual occupants. Accordingly, the estimation accuracy in the request estimation unit 208 to be described later is further improved. The sensors mentioned here include the internal camera 21 and the microphone 22. The occupant information includes voice content recognized by the voice recognition unit 204. The occupant information includes information derived from an image of the occupant detected by the internal camera 21 (hereinafter referred to as image derived information). The image derived information includes at least one of an occupant state of face image of the occupant detected by the internal camera 21, a feature amount extracted from the face image, a behavior, or a posture of the occupant detected by the internal camera 21. Examples of the occupant state include an awakening level of occupant, a face direction of occupant, a line-of-sight direction of occupant, and a posture of occupant. The occupant information specifying unit 206 may specify, by referring to the attribute specifying information stored in the personal DB 205, which occupant outputs the voice content based on the voiceprint. For the image derived information, the occupant information specifying unit 206 may specify, by referring to the attribute specifying information stored in the personal DB 205, the image derived information is derived from which occupant based on the feature amount extracted from the face image. The boarding position of occupant may be specified using a position specified by the occupant authentication unit 201. Regarding the voice content, in a case where the microphone 22 is provided for each seat, according to the voice content is recognized from sound collected by which microphone 22, the voice content of occupant in which boarding position can be specified. The method of specifying voice content and the image derived information by distinguishing the individual occupants is not limited to the method described above.

In the present embodiment, the internal camera 21 detects the awakening level, the face direction, the line-of-sight direction, and the posture of occupant as the occupant state. However, the present disclosure is not limited thereto. For example, a psychological state of occupant may be estimated as the occupant state based on the feature amount of face image of the occupant captured by the internal camera 21. Instead of detecting the awakening level, the face direction, the line-of-sight direction, the posture, or the psychological state of the occupant by the internal camera 21, the occupant information specifying unit 206 may have a function of detecting the awakening level, the face direction, the line-of-sight direction, the posture, or the psychological state of the occupant.

The supplementary information acquiring unit 207 acquires the supplementary information described above. The supplementary information acquiring unit 207 may acquire supplementary information from the personal DB 205. When the personal DB 205 is located in a center outside the host vehicle, the supplementary information acquiring unit 207 may acquire the supplementary information from the center via the WACM 5.

The request estimation unit 208 estimates a request of occupant according to a combination of occupant information records of multiple occupants based on the occupant information records of multiple occupants of the host vehicle specified by the occupant information specifying unit 206. The process executed by the request estimation unit 208 corresponds to a request estimation step. The request estimation unit 208 may estimate requests for all of multiple occupants in the host vehicle or may estimate requests for a part of the occupants. The request estimation unit 208 may estimate the request of occupant according to the combination of occupant information records of multiple occupants based on the occupant information records of multiple occupants using a learning device which has been trained with a machine learning. In this case, as the learning device, a learning device obtained by machine learning in which a combination of occupant information records of multiple occupants is input and an occupant request corresponding to the combination is output may be used. The request estimation unit 208 may estimate the request of occupant based on a correspondence relationship between a combination of occupant information records of multiple occupants and the request of occupant estimated from the combination. The correspondence relationship may be obtained based on a hearing from multiple test users. Hereinafter, a case where the request estimation unit 208 estimates the request of occupant by the above-described learning device will be described as an example.

The request estimation unit 208 may estimate the request of occupant according to a combination of voice contents of multiple occupants based on the voice contents of multiple occupants in the host vehicle specified by the occupant information specifying unit 206. In this case, it is preferable to use, as the learning device, a learning device that performs machine learning for estimating the request of occupant according to conversation content, which is a flow of voice contents of multiple occupants, by also inputting an order by which the voice contents are made in the flow. In this learning device, even when the voice content has not been learned, the request of occupant according to the combination of voice contents of multiple occupants may be estimated from a similarity of an element of the voice content. It is preferable that the request estimation unit 208 estimates a background of conversation content based on the conversation content, which is a flow of voice contents of multiple occupants in the host vehicle specified by the occupant information specifying unit 206, and estimates the occupant request suitable for the background of conversation content. In this case, estimation may be performed step by step, such as estimating the background from the conversation content and estimating the request of occupant from the estimated background. Accordingly, it is possible to more accurately estimate the request of occupant even when a request of occupant is difficult to be estimated only by understanding voice contents of multiple occupants. The background here may be referred to as context. That is, the term “background” as used herein can be read as context, connexion, circumstance, or the like.

The request estimation unit 208 preferably estimates the request of occupant of the host vehicle based on the supplementary information acquired by the supplementary information acquiring unit 207 in addition to the occupant information records of multiple occupants of the host vehicle specified by the occupant information specifying unit 206. In this case, as the learning device, a learning device that performs machine learning for estimating the request of occupant according to the supplementary information may be used. According to this configuration, it is possible to more accurately estimate the request of occupant by responding to the preference of occupant and the past action history of occupant.

The following will describe an example of estimating the request of occupant according to a combination of voice contents of multiple occupants. The following settings is defined as case A. Multiple occupants who have made voice contents are three persons, namely, the wife on the front passenger seat, the son on the rear seat, and the daughter on the rear seat. The order of voice contents is wife, son, and daughter. The voice content of wife is “It is pity that we cannot see any firefly this year.” The voice content of son is “Yes! we saw fireflies around this place! You are right. The fireflies were so beautiful last year.” The voice content of daughter is “Yes! I want to see them again.” It is assumed that the voice contents of the wife, the son, and the daughter are specified by the occupant information specifying unit 206 in distinguishable manner.

The request estimation unit 208 estimates that the wife on the front passenger seat is speaking to the son and the daughter who are on the rear seats from the voice contents and an order of voice contents. The request estimation unit 208 may estimate that the wife is talking to the son and the daughter on the rear seats based on not only the voice contents but also the face direction of wife specified by the occupant information specifying unit 206. From the character strings of “we cannot see any firefly” and “it is pity”, it is estimated that the wife feels disappointed and the reason is that she cannot see any firefly. Furthermore, the voice content of son, such as “you are right”, the voice content of daughter, such as “Yes! I want to see them again”, it is estimated that all the three people feel disappointed and that the reason of disappointment is the firefly cannot be seen as the background. Then, from the estimated result, the request of occupant is estimated as seeing of firefly. In case A, the request of occupant is estimated as seeing of firefly.

It should be noted that the vicinity of current position is a habitat of firefly based on the character string “we saw fireflies around this place!”, which is made by the son. Then, based on the estimation result, a movement history in which a photograph was taken around the current position in the last year may be extracted from the movement history of wife, and the photograph in which the firefly appears may be extracted. The estimation of request of occupant to see the firefly may be reinforced from the movement history in which a photograph showing the firefly was taken around the current position in the last year.

As another example, the following settings is defined as case B. Multiple occupants who have made voice contents are the wife on the driver seat and a friend of the wife on the front passenger seat. The order of voice contents is wife, friend of wife, and wife. The first voice content of wife is “An apple pie store that was recently opened in ZZ mall is very delicious. Recently I fed my family with it and they said delicious.” The voice content of wife's friend is “Huh! I'm curious! I like apple pie. I want to eat! What is the name of that store?” The second voice content of wife is “I wonder what the name is. I have forgotten. It is a rather long name in English.”

The request estimation unit 208 estimates that the wife and the friend of wife have a conversation from the voice contents and an order of voice contents. It is estimated that the friend of wife wants to eat the apple pie of ZZ mall from the character string of wife “An apple pie store that was recently opened in ZZ mall is very delicious.” and the character string of wife's friend “I want to eat!” Based on this estimation result, character string of wife's friend “What is the name of that store?” and character string of wife “I wonder what the name is. I have forgotten. It is a rather long name in English”, a background in which the wife should remember the name of apple pie store in ZZ mall can be inferred. Then, from the estimated result, the request of occupant is estimated as knowing of the name of apple pie store in ZZ mall.

As another example, the following settings is defined as case C. Multiple occupants who have made voice contents are the husband on the driver seat and the wife on the front passenger seat. The order of voice contents is wife and husband. The voice content of wife is “It is lunch time soon”. The voice content of husband is “At lunch time, every restaurant is crowded.”

The request estimation unit 208 estimates that the wife and the husband have a conversation based on the voice contents and an order of the voice contents. Based on the character string of wife “It is lunch time soon” and the character string of husband “At lunch time, every restaurant is crowded”, a background in which they want to quickly find a restaurant is estimated. Then, from the estimated result, the request of occupant to have lunch in a restaurant near the current position can be estimated. When the preference information of occupant included in the supplementary information, which is acquired by the supplementary information acquiring unit 207, is also used, the following estimation may be made. For example, when preference information indicating that both the wife and the husband like ramen can be acquired, the request of occupant to eat in a ramen restaurant near the current position may be estimated.

The request estimation unit 208 may estimate the request of occupant according to ae combination of occupant states of multiple occupants based on the above-described occupant states of multiple occupants in the host vehicle specified by the occupant information specifying unit 206. According to this configuration, even in a situation where a conversation does not occur, it is possible to more accurately estimate the request of occupant. It is preferable that the request estimation unit 208 estimates a background of the occupant states based on the occupant states of multiple occupants in the host vehicle specified by the occupant information specifying unit 206, and estimates the request of occupant suitable for the background. In this case, the estimation may be performed step by step such that the background is estimated from the combination of the occupant states of multiple occupants first, and then the request of occupant is estimated based on the estimated background. With this configuration, it is possible to more accurately estimate the request of occupant. The occupant information used by the request estimation unit 208 to estimate the request of occupant may be a combination of the voice contents and the occupant states.

The following will describe an example of estimating a request of occupant according to a combination of occupant states of multiple occupants. The following settings is defined as case D. It is assumed that multiple occupants whose occupant states are specified include two persons, that is, a wife on the driver seat and an infant on the rear seat. The occupant state of infant is a state in which an awakening level is low. The state in which the awakening level is low may be a state in which the user is asleep or a state in which the drowsiness is equal to or higher than a certain level. The occupant state of wife is looking backward. The request estimation unit 208 estimates, from a combination of the occupant states, a background that the wife is concerned about whether the infant is sleeping or not. Then, from the estimated background, it can be estimated that the request of wife is to clearly check the state of infant.

As another example, the following settings is defined as case E. It is assumed that multiple occupants whose occupant states are specified include two persons, that is, a wife on the driver seat and an infant on the rear seat. The occupant state of infant is a state in which an awakening level is low. The occupant state of wife is line of sight directing to a rearview mirror and a confused psychological state. The request estimation unit 208 estimates, from a combination of these occupant states, a background in which the wife is concerned about whether the infant is sleeping or not, but the inside of vehicle compartment is dark and infant state cannot be checked in the rearview mirror. Then, from the estimated background, it can be estimated that the request of wife is to clearly check the state of infant.

As another example, the following settings is defined as case F. It is assumed that multiple occupants whose occupant states are specified include two persons, that is, a wife on the driver seat and an infant on the rear seat. The occupant state of infant is a state in which the occupant is not asleep but has a low awakening level. The occupant state of wife is line of sight directing to a rearview mirror and silence. Silence may be specified from presence or absence of voice content, or may be specified from an open or closed state of a mouth in the face image. The request estimation unit 208 estimates the background in which the wife wants to let the infant to fall asleep from the combination of the occupant states. Then, from the estimated background, the request of wife is estimated to make the vehicle environment easy for the infant to fall asleep. When the preference information of occupant included in the supplementary information, which is acquired by the supplementary information acquiring unit 207, is also used, the following estimation may be made. For example, in a case where the preference information indicating that a song is usually played back while the infant falls asleep and this preference information can be acquired, the request of wife is estimated to playback of this song in the vehicle.

The internal environment specifying unit 209 specifies the internal environment of host vehicle estimated to satisfy the request of occupant estimated by the request estimation unit 208. Then, the provision processing unit 203 provides the internal environment specified by the internal environment specifying unit 209. The provision processing unit 203 may provide the internal environment specified by the internal environment specifying unit 209 by providing visual content, auditory content, lighting, in-vehicle air conditioning, fragrance, conversation with in-vehicle AI, and the like singly or in combined manner. The provision processing unit 203 may control the display device 24 to provide a visual content. The provision processing unit 203 may control the audio output device 25 to provide an auditory content and a conversation with the in-vehicle AI. The provision processing unit 203 may control the lighting device 23 to provide illumination. The provision processing unit 203 may control the air conditioning unit 31 to provide the in-vehicle air conditioning via the air conditioning control ECU 30. The provision processing unit 203 may control the aroma unit 32 to provide an aroma via the air conditioning control ECU 30.

The internal environment specifying unit 209 may estimate the internal environment of the host vehicle that satisfies the request of occupant estimated by the request estimation unit 208 based on the request of occupant estimated by the request estimation unit 208 using a learning device in which a machine learning has been performed. In this case, as the learning device, a learning device obtained by machine learning in which a request of occupant is input and an internal environment of vehicle satisfying the request is output may be used. The internal environment specifying unit 209 may estimate the internal environment satisfying the request of occupant based on a correspondence relationship between the request of occupant and the internal environment of vehicle satisfying the request. The correspondence relationship may be obtained based on a hearing from multiple test users.

The following will describe an example of estimation of internal environment in accordance with a request of occupant estimated by the request estimation unit 208 and provision of the internal environment. In the case A described above, the following operations may be performed. In the case A, the request of occupant is estimated as seeing of firefly. In response to this request, the internal environment specifying unit 209 may estimate the internal environment in which the firefly image is displayed. The internal environment specifying unit 209 may estimate an internal environment that provides an atmosphere when the occupants saw the fireflies last year. Then, the provision processing unit 203 may display a firefly image or provide an atmosphere when fireflies were seen last year. When the movement history information in the personal DB 205 includes a firefly image captured last year, the provision processing unit 203 may control the display device 24 to display the firefly image. The provision processing unit 203 may acquire a firefly video from the center via the WACM 5 and may display the acquired firefly video on the display device 24. In a case where the video also has corresponding audio, the provision processing unit 203 may output the audio from the audio output device 25. The atmosphere when firefly was seen last year may be provided as follows. The provision processing unit 203 may control an air conditioning temperature of the air conditioning unit 31 via the air conditioning control ECU 30 such that the room temperature matches the temperature of habitat of fireflies. The provision processing unit 203 may adjust the light in the vehicle compartment so that the brightness is adjusted to the time when the occupants saw the fireflies last year. The brightness control of lighting may be implemented by controlling the lighting device 23 or controlling the room light.

In the case B described above, the following operations may be performed. In the case B, the request of occupant is estimated as to know the name of apple pie store in ZZ mall. In response to this request, the internal environment specifying unit 209 may estimate an internal environment in which a voice asking the name of apple pie store in ZZ mall is output. Then, the provision processing unit 203 may output a voice inquiring about the name of apple pie store in ZZ mall. The provision processing unit 203 may specify XX, which is the name of apple pie store in ZZ mall, by searching the Internet via the WACM 5. As an example of the voice output, the provision processing unit 203 may control the audio output device 25 to output a voice, such as “Is the store you have just discussed XX store?” at a timing of gap in the conversation between the wife and the friend of wife. The provision processing unit 203 may control the display device 24, such as a CID to display information on apple pie store in ZZ mall. Accordingly, when the occupants have a conversation with each other, the conversation between the occupants may be assisted.

In the case C described above, the following operations may be performed. In the case C, the request of occupant is estimated as to eat in a restaurant near the current position. In response to this request, the internal environment specifying unit 209 may estimate an internal environment in which a voice suggesting a restaurant near the current position is output. Then, the provision processing unit 203 may control the audio output device to output a voice suggesting a restaurant near the current position. The provision processing unit 203 may specify a restaurant near the current position by searching the Internet via the WACM 5. As an example of voice output, the provision processing unit 203 may control the audio output device 25 to output a voice, such as “There is a restaurant called YY 100 meters ahead” at a timing of a gap in the conversation between the husband and the wife. The provision processing unit 203 may control the display device 24, such as a CID to display information about the suggested restaurant or map information indicating the position of restaurant.

In the cases D and E described above, the following operations may be performed. In the cases D and E, it is estimated that the wife wants to clearly check the state of infant. In response to this request, the internal environment specifying unit 209 may estimate an internal environment in which the state of the infant is displayed on the display device 24 to be easily viewed by the wife. Then, the provision processing unit 203 may display the state of infant on the display device 24 such that the state of infant can be easily viewed by the wife. The provision processing unit 203 may control the display device 24, such as a CID or a meter MID to display the image of infant captured by the internal camera 21. When the occupant information specifying unit 206 specifies that the infant is asleep, the audio output device 25 may be controlled to output an audio notifying that the infant is asleep at a low audio volume together with the image display of the infant. Here, the low audio volume may be a volume that is estimated not to disturb the sleeping infant.

In the case F described above, the following operations may be performed. In the case F, it is estimated that the wife wants to set the vehicle compartment environment such that the infant can easily fall asleep. In response to this request, the internal environment specifying unit 209 may estimate an internal environment in which the infant can easily fall asleep. Then, the provision processing unit 203 may provide the internal environment in which the infant can easily fall asleep. In a case where there is a piece of music that is usually played back when the infant falls asleep, the provision processing unit 203 may control the audio output device 25 to output the piece of music with a reduced volume. In a case where there is no music that is usually played back when the infant falls asleep, the volume of music currently output from the audio output device 25 may be lowered. When a preference speaker is used as the audio output device 25, it is only necessary to make it difficult for the sound to reach the area in the vehicle compartment where the infant is located. The air conditioning unit 31 may be controlled via the air conditioning control ECU 30 to adjust the room temperature and the air volume such that the infant can relax. The temperature may be adjusted using a seat heater. The same may be applied to a case where the target who requests to sleep is an adult passenger other than the infant. In this case, an internal environment in which the driver is likely to sleep is not provided for an area where the driver is located in the vehicle compartment.

When the request estimation unit 208 estimates a request that the occupant wants some entertainment, the provision processing unit 203 may provide an internal environment that the occupant can easily enjoy. For example, the provision processing unit 203 may search for music preferred by the occupant based on the preference information in the personal DB 205, and output the music from the audio output device 25. In this case, in order not to impair the mood of occupant, it is preferable to inquire the occupant and obtain permission for reproduction before outputting the music.

When the request estimation unit 208 estimates a request to shake off the drowsiness of occupant, the provision processing unit 203 may provide an internal environment in which the drowsiness of the occupant can be easily shaken off. For example, the provision processing unit 203 may control the air conditioning unit 31 via the air conditioning control ECU 30 to blow cold air toward the vehicle compartment. Further, the provision processing unit 203 may control the aroma unit 32 via the air conditioning control ECU 30 to blow an aroma having an awakening effect toward the vehicle compartment. The provision processing unit 203 may control the audio output device 25 to output up-tempo music. When the occupant is the driver, the provision processing unit 203 may control the audio output device 25 to output an audio for calling attention.

(Provision Related Process by HCU 20)

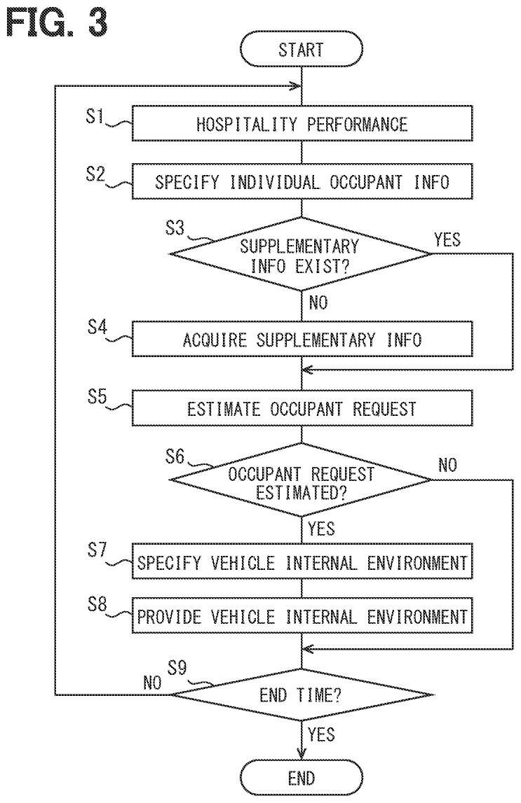

The following will describe an example of flow of provision related process executed by HCU 20 with reference to a flowchart shown in FIG. 3. The flowchart of FIG. 3 may be started, for example, when the occupant authentication unit 201 authenticates that occupant is the authorized occupant of the host vehicle.

In step S1, the provision processing unit 203 provides an internal environment of hospitality performance. In step S2, the occupant information specifying unit 206 specifies the occupant information detected by a sensor of the host vehicle in distinguishable manner.

In step S3, when there are supplementary information for the occupants specified in S2 (YES in S3), the process proceeds to step S4. When there is no supplementary information for the occupants specified in S2 (NO in S3), the process proceeds to step S5. In step S4, the supplementary information acquiring unit 207 acquires supplementary information of the occupants specified in S2, and the process proceeds to step S5.

In step S5, the request estimation unit 208 estimates the request of occupant according to the combination of occupant information records of multiple occupants based on the occupant information records of multiple occupants of the host vehicle specified by the occupant information specifying unit 206. In step S6, when the request of occupant can be estimated (YES in S6), the process proceeds to step S7. In step S6, when the request of occupant cannot be estimated (NO in S6), the process proceeds to step S9.

In step S7, the internal environment specifying unit 209 specifies the internal environment of the host vehicle estimated to satisfy the request of occupant estimated in S5. In step S8, the provision processing unit 203 provides the internal environment specified in S7.

In step S9, when it is the end time of provision related process (YES in S9), the provision related process is ended. In step S9, when it is not the end time of provision related process (NO in S9), the process returns to S2 to repeat the process. An example of the end time of provision related process may be turn-off time of a power switch of the host vehicle.

### Summary of First Embodiment

According to the configuration of the first embodiment, since the multiple individual occupants in the host vehicle are distinguishably specified and the occupant request according to the combination of occupant information records of multiple occupants is estimated based on the occupant information records of multiple occupants in the host vehicle, it is possible to more accurately estimate the occupant request that changes depending on the relationship among multiple occupants and the states of multiple occupants. Since the occupant information is information on the occupant of the host vehicle detected by the sensor of the host vehicle, it is possible to more accurately estimate the request of occupant suitable for the actual situation. As a result, it is possible to provide a comfortable indoor experience more suitable for the request of occupant by more accurately estimating the request of occupant when multiple occupants exist in the vehicle.

### Second Embodiment

In the above-described embodiment, the HCU 20 authenticates whether the occupant is an authorized occupant of the host vehicle. The present disclosure is not limited thereto. For example, the functions of occupant authentication unit 201 and authentication DB 202 may be executed by an electronic control unit other than the HCU 20.

### Third Embodiment

In the above-described embodiments, any one of the voice content or the occupant state is used as the occupant information. The present disclosure is not necessarily limited thereto. For example, only one of the voice content and the occupant state may be used as the occupant information.

### Fourth Embodiment

In the above-described embodiment, the vehicle system 1 is described to be used in an automobile. The present disclosure is not necessarily limited thereto. The vehicle system 1 may be applied to a mobile object other than an automobile as long as the mobile object can accommodate multiple occupants. For example, the present disclosure may be applied to a mobile object such as a railway vehicle, an aircraft, or a ship.

Note that the present disclosure is not limited to the embodiments described above and can variously be modified within the scope of the present disclosure. An embodiment obtained by appropriately combining the technical features disclosed in different embodiments may also be included in the technical scope of the present disclosure. Further, the control unit and the method thereof described in the present disclosure may be implemented by a dedicated computer which includes a processor programmed to perform one or more functions executed by a computer program. Alternatively, the device and the method thereof described in the present disclosure may also be implemented by a dedicated hardware logic circuit. Alternatively, the device and the method thereof described in the present disclosure may also be implemented by one or more dedicated computers configured as a combination of a processor executing a computer program and one or more hardware logic circuits. The computer programs may be stored, as instructions to be executed by a computer, in a tangible non-transitory computer-readable storage medium.

What is claimed is:

1. A device for mobile object, the device being usable in a mobile object, the device comprising:
an occupant information specifying unit specifying an occupant information record for each of multiple occupants existing in the mobile object by distinguishing the multiple occupants from one another, the multiple occupants being detected by a sensor of the mobile object; and
a request estimation unit estimating a request of one of the multiple occupants corresponding to a combination of the occupant information records of the multiple occupants based on the occupant information records of the multiple occupants specified by the occupant information specifying unit,
wherein
the occupant information specifying unit specifies, as the occupant information record, a voice content of each of the multiple occupants by distinguishing the multiple occupants from one another,
the voice content of each of the multiple occupants is detected by the sensor of the mobile object, which detects a sound in a compartment of the mobile object,
the request estimation unit estimates the request of one of the multiple occupants corresponding to a combination of the voice contents of the multiple occupants based on the voice contents of the multiple occupants specified by the occupant information specifying unit, and
the request estimation unit estimates a background of a conversation content based on the conversation content that is a flow of the voice contents of the multiple occupants specified by the occupant information specifying unit, and estimates the request of one of the multiple occupants to match the estimated background.

2. The device for mobile object according to claim 1, further comprising:
an internal environment specifying unit specifying an internal environment of the mobile object, which is estimated to satisfy the request of one of the multiple occupant estimated by the request estimating unit; and
a provision processing unit providing the internal environment specified by the internal environment specifying unit.

3. The device for mobile object according to claim 1, wherein
the occupant information specifying unit specifies, as the occupant information record, an occupant state of each of the multiple occupants by distinguishing the multiple occupants from one another,
the occupant state is at least one of an action or a posture of each of the multiple occupants, and the action or the posture of each of the multiple occupants is detected by the sensor of the mobile object, which photographs inside of a compartment of the mobile object, and
the request estimation unit estimates the request of one of the multiple occupants corresponding to a combination of the occupant states of the multiple occupants based on the occupant states of the multiple occupants specified by the occupant information specifying unit.

4. The device for mobile object according to claim 1, further comprising
a supplementary information acquiring unit acquiring supplementary information, which is at least one of information on preference of one of the multiple occupants or information on a past action history of one of the multiple occupants,
wherein the request estimation unit estimates the request of one of the multiple occupants based on the supplementary information acquired by the supplementary information acquiring unit in addition to the occupant information records of the multiple occupants specified by the occupant information specifying unit.

5. A control method for mobile object to be executed by at least one processor, the control method for mobile object being usable in a mobile object, the control method for mobile object comprising:
specifying an occupant information record for each of multiple occupants existing in the mobile object by distinguishing the multiple occupants from one another, the multiple occupants being detected by a sensor of the mobile object;
estimating a request of one of the multiple occupants corresponding to a combination of the occupant information records of the multiple occupants based on the specified occupant information records of the multiple occupants;
detecting a voice content of each of the multiple occupants using the sensor of the mobile object, which detects a sound in a compartment of the mobile object;
specifying, as the occupant information record, the voice content of each of the multiple occupants by distinguishing the multiple occupants from one another;
estimating the request of one of the multiple occupants corresponding to a combination of the voice contents of the multiple occupants based on the specified voice contents of the multiple occupants;
estimating a background of a conversation content based on the conversation content that is a flow of the specified voice contents of the multiple occupants; and
estimating the request of one of the multiple occupants to match the estimated background.

6. A device for mobile object, the device for mobile object being usable in a mobile object, the device for mobile object comprising:
a computer-readable non-transitory storage medium storing a control program; and
at least one processor, by executing the control program stored in the computer-readable non-transitory storage medium, configured to:
specify an occupant information record for each of multiple occupants existing in the mobile object by distinguishing the multiple occupants from one another, the multiple occupants being detected by a sensor of the mobile object;
estimate a request of one of the multiple occupants corresponding to a combination of the occupant information records of the multiple occupants based on the specified occupant information records of the multiple occupants;
detect a voice content of each of the multiple occupants using the sensor of the mobile object, which detects a sound in a compartment of the mobile object;
specify, as the occupant information record, the voice content of each of the multiple occupants by distinguishing the multiple occupants from one another;
estimate the request of one of the multiple occupants corresponding to a combination of the voice contents of the multiple occupants based on the specified voice contents of the multiple occupants;
estimate a background of a conversation content based on the conversation content that is a flow of the specified voice contents of the multiple occupants; and
estimate the request of one of the multiple occupants to match the estimated background.
